(19) United States
(12) Patent Application Publication
(10) Pub. No.: US 2026/0093563 A1
(43) Pub. Date: Apr. 2, 2026

(54) CLIPBOARD INTERFACE

(71) Applicant: Lenovo (United States) Inc., Morrisville, NC (US)

(72) Inventors: Wenyu Du, Beijing (CN); Jung Hwan Hong, Cary, NC (US); Rod D. Waltermann, Rougemont, NC (US); Christopher Smith, Franklinton, NC (US)

(21) Appl. No.: 18/902,734

(22) Filed: Sep. 30, 2024

(51) Int. Cl. G06F 9/54; G06F 3/04817; G06F 9/451

(52) U.S. Cl. CPC G06F 9/543; G06F 3/04817; G06F 9/451

(57) ABSTRACT

One embodiment provides a method, the method including: receiving, at a clipboard interface system, an indication to access a clipboard storing a copy history of a user; presenting, responsive to the receiving the indication, a graphical user interface for the clipboard and displaying a recent copy history of the user within the graphical user interface; receiving, at the clipboard interface system, a second indication to view an expanded graphical user interface; and expanding, responsive to the receiving the second indication, the graphical user interface for the clipboard into an expanded graphical user interface and displaying additional copy history in addition to the recent copy history within the expanded graphical user interface. Other aspects are claimed and described.

### BACKGROUND

When users are utilizing devices, users often want to move information from one location to another. For example, the user may want to copy information contained within one application to another application. In the copy function, the system copies the information to a buffer. When the user identifies the destination location, the system utilizes the information contained in the buffer and duplicates it in the destination location. As another example, the user may want to cut information from one document and place it within another document. In the cut function, the system copies the information to a buffer and then deletes it from the originating location. When the user identifies the destination location, the system utilizes the information contained in the buffer and duplicates it in the destination location. Even when the user deletes information, the deleted information is stored in a buffer. This buffer is often referred to as a clipboard. The clipboard is a buffer that provides for short-term storage and transfer of information. Generally, when the user logs off a computing device, turns off a computing device, and/or the like, the buffer is reset and all the information contained within the buffer is deleted or removed.

### BRIEF SUMMARY

In summary, one aspect provides a method, the method including: receiving, at a clipboard interface system, an indication to access a clipboard storing a copy history of a user; presenting, responsive to the receiving the indication, a graphical user interface for the clipboard and displaying a recent copy history of the user within the graphical user interface; receiving, at the clipboard interface system, a second indication to view an expanded graphical user interface; and expanding, responsive to the receiving the second indication, the graphical user interface for the clipboard into an expanded graphical user interface and displaying additional copy history in addition to the recent copy history within the expanded graphical user interface.

Another aspect provides a system, the system including: a processor; a memory device that stores instructions that, when executed by the processor, causes the system to: receive, at a clipboard interface system, an indication to access a clipboard storing a copy history of a user; present, responsive to the receiving the indication, a graphical user interface for the clipboard and displaying a recent copy history of the user within the graphical user interface; receive, at the clipboard interface system, a second indication to view an expanded graphical user interface; and expand, responsive to the receiving the second indication, the graphical user interface for the clipboard into an expanded graphical user interface and displaying additional copy history in addition to the recent copy history within the expanded graphical user interface.

A further aspect provides a product, the product including: a computer-readable storage device that stores executable code that, when executed by a processor, causes the product to: receive, at a clipboard interface system, an indication to access a clipboard storing a copy history of a user; present, responsive to the receiving the indication, a graphical user interface for the clipboard and displaying a recent copy history of the user within the graphical user interface; receive, at the clipboard interface system, a second indication to view an expanded graphical user interface; and expand, responsive to the receiving the second indication, the graphical user interface for the clipboard into an expanded graphical user interface and displaying additional copy history in addition to the recent copy history within the expanded graphical user interface.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for presenting a graphical user interface for a clipboard that stores a copy history of a user that allows for quick toggling between a recent clipboard view and an expanded clipboard view that displays more of the copy history of the user based upon receipt of an indication to do so.

FIG. 4 illustrates an example user interface icon for accessing the clipboard.

FIG. 5 illustrates an example recent clipboard view.

FIG. 6 illustrates an example expanded clipboard view.

### DETAILED DESCRIPTION

The clipboard provides a storage buffer that allows the user to store information for use within other windows, applications, instances of the same application, and even in the same document or instance of an application, and/or the like. The clipboard is what facilitates the copy, cut, and paste features because the clipboard gives the system some place to store the information that can then be accessed at a later time without taking up long-term memory space. Getting information (e.g., text, images, pointer, etc.) included on the clipboard is relatively easy because there are many different techniques that exist for getting the information included on the clipboard. For example, a user can select a copy or cut function from a menu, utilize a set of shortcut keys, provide input to a keyboard key, and/or the like. All of these techniques will result in the selected information being added to the clipboard. Additionally, getting the most recent information that was added to the clipboard can also be relatively easy by, for example, utilizing a set of shortcut keys, selecting a function from a menu, and/or the like.

However, if the user wants to access information that has been placed on the clipboard but is not the most recent information that was placed on the clipboard, accessing this information is more difficult. Many users do not even know that information past the most recent information can be accessed using a secret shortcut set of keys in certain operating systems. Additionally, the number of items stored in this clipboard is limited. Other operating systems may provide a clipboard that allows a user to transfer information across devices, but this system does not allow for storage of a history of copied information. Instead, the user can only transfer the most recently copied information. Other clipboards that are associated with specific device manufacturers may provide a visual clipboard history that allows a user to the last few items that were stored on the clipboard, even across the devices. However, the number of items accessible via the clipboard are limited. Additionally, in the cases that allow for access to more than one item, a user has to scroll within the display in order to access any of these items past the most recent one, with each item being displayed individually.

Accordingly, the described system and method provides a technique for presenting a graphical user interface for a clipboard that stores a copy history of a user that allows for quick toggling between a recent clipboard view and an expanded clipboard view that displays more of the copy history of the user based upon receipt of an indication to do so. The system receives an indication to access a clipboard storing a copy history of the user. A copy history of a user may include not only those items that were specifically copied by a user, but also those items that need to be copied in order to perform a different function, for example, a cut function, a paste function, and/or the like. Additionally, other functions may cause information to be stored on the clipboard, for example, a delete function may temporarily store the information on a clipboard in case the user wants to reverse the delete action. The indication to access the clipboard may be an input that is provided at or directed to an icon that is associated with the clipboard, for example, clicking on the icon, hovering over the icon, and/or the like.

In response to receipt of the indication, the system presents a graphical user interface for the clipboard that displays a recent copy history of the user within the interface. Presenting the graphical user interface may include changing the appearance of the icon into the user interface. In other words, the icon may be transformed into the user interface that contains the recent copy history of the user. The recent copy history includes no more than a predetermined number of items that have been stored on the clipboard. The system may then receive a second indication to view an expanded graphical user interface. This second indication may include receipt of an input that corresponds to the expanded graphical user interface. In response to receipt of this second indication, the system expands the graphical user interface from the previous graphical user interface to an expanded graphical user interface. The expanded graphical user interface displays the copy history that was included with the previous graphical user interface and additionally displays additional copy history. In other words, the original graphical user interface displays a certain number of items and the expanded graphical user interface displays those items plus additional items.

Therefore, a system provides a technical improvement over traditional methods for providing a clipboard and clipboard interface. Instead of traditional techniques that allow only a single view, the described system and method provides an interface that can be expanded from a basic or recent clipboard view to an expanded clipboard view that includes additional copy history. Additionally, the clipboard graphical user interface is easy to access without requiring the user to know a secret shortcut set of keys, unlike traditional methods. The described system and method also allows access to more items that are stored on the clipboard than traditional techniques and the user is also able to quickly see and access the desired information, without having to perform extensive scrolling that only displays a single item of information at a time.

Thus, the described system and method provides a graphical user interface for accessing information stored on a clipboard that is more accessible, provides a way to more easily view information stored on the clipboard, and that is more user friendly than traditional techniques.

The illustrated example embodiments will be best understood by reference to the figures. The following description is intended only by way of example, and simply illustrates certain example embodiments.

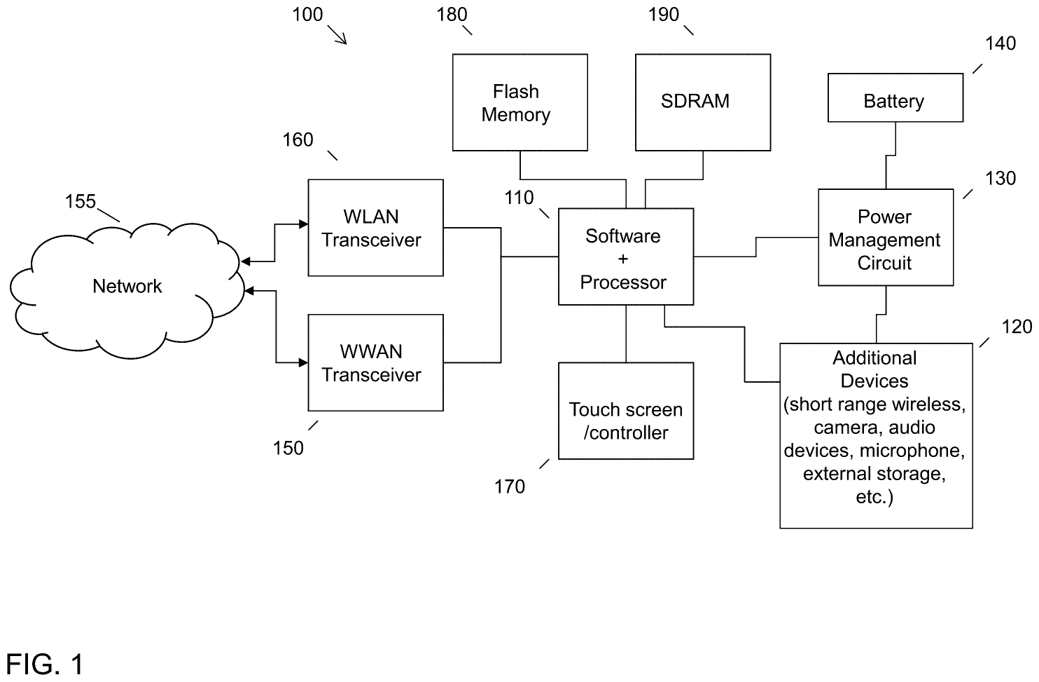

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

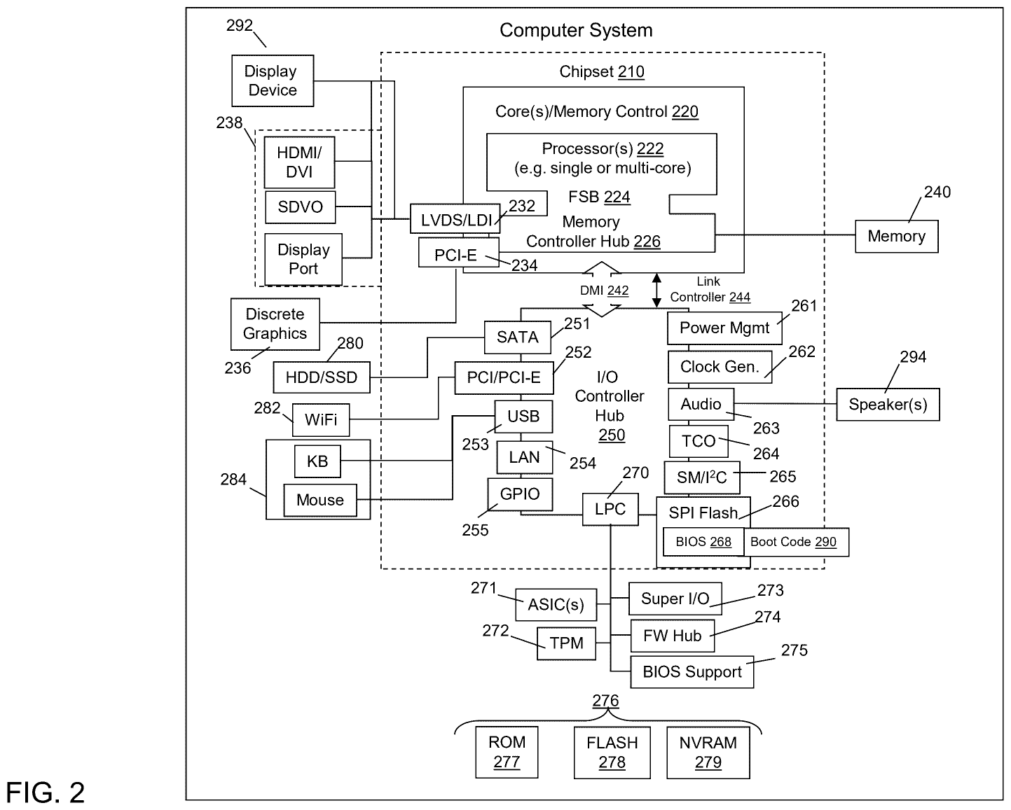

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may utilize the clipboard features discussed herein. For example, the circuitry outlined in FIG. 1 may be implemented in a tablet or smart phone embodiment, whereas the circuitry outlined in FIG. 2 may be implemented in a personal computer embodiment.

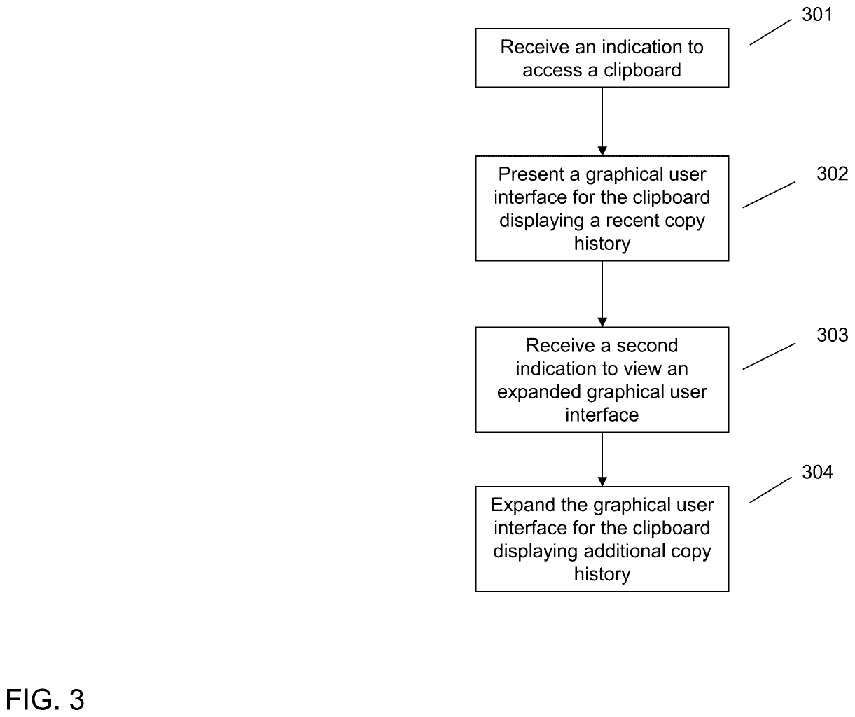

FIG. 3 illustrates an example method for presenting a graphical user interface for a clipboard that stores a copy history of a user that allows for quick toggling between a recent clipboard view and an expanded clipboard view that displays more of the copy history of the user based upon receipt of an indication to do so. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to present a graphical user interface for a clipboard that allows toggling between different views displaying different amounts of copy history of a user. Additionally, the clipboard interface system includes modules and features that are unique to the described system.

Activation of the clipboard interface system may be a manual activation of the clipboard interface system and/or an automatic activation of the clipboard interface system. The automatic activation of the clipboard interface system may be based upon the detection of a trigger event indicating that the system should be activated.

The clipboard interface system may be made of multiple systems or modules that communicate together to make up the clipboard interface system or may be a single system. The clipboard interface system may be a standalone system, may be accessible through other computing devices, and/or a combination thereof. For example, the clipboard interface system may be a standalone system that can be accessed by a user and/or may be or provide an application that is accessible by a user on another computing device. The clipboard interface system may be accessible using any type of computing device, for example, personal computer, laptop computer, smartphone, tablet, smartwatch, head-mounted display, smart television or other smart appliance, augmented reality device, virtual reality device, and/or the like.

Thus, the clipboard interface system may be accessible locally using a computing device where the clipboard interface system is installed and/or may be accessible remotely through another computing device. For example, the clipboard interface system may be accessed by a user using a device that communicates with the clipboard interface system. However, the clipboard interface system may be located and operate on a different information handling device as compared to the device being utilized by the user to perform the described steps.

The clipboard interface system may include different components for carrying out different functions of the system, including different steps to be performed. These components may be hardware components or software components. Some hardware devices or components that may be utilized by the clipboard interface system include input devices that may be utilized to receive input from the user, for example, mechanical input modalities (e.g., keyboard, mouse, etc.), touch input devices, gesture input devices, electromyography input devices, audio input devices, image capture devices, and/or the like. Other hardware components may be utilized to provide output from the clipboard interface system. For example, the clipboard interface system may include speakers, displays or monitors, haptic output devices, audio output devices, and/or the like. Other hardware components may be included.

One software component includes the user profile that stores information related to the user and user preferences. The user profile may be unique to a user and may assist in identifying what indications are used to access the graphical user interface and the expanded graphical user interface, how many items are displayed in the graphical user interface, how many items are displayed in the expanded graphical user interface, and/or the like. The user profile may include user preferences. The user profile may also include other information about the user that seems to influence the clipboard interface system, for example, a device that the user is using during different sessions, a location where the user is located when the graphical user interface is accessed, different applications that allow for storage on a clipboard, and/or the like.

The user may manually input data into the profile or the information within the profile may be populated by the system as the system learns about the user over time. For example, the system may utilize an artificial intelligence model to learn about the user, make correlations between information received about the user and the clipboard interface system, and/or the like. This information can be populated within the user profile for use by the system during subsequent video capture sessions.

At 301, the clipboard interface system receives an indication to access a clipboard storing a copy history of a user. The clipboard stores items and information. Any of the items and information that is stored on the clipboard is referred to as the copy history. To get items and information onto the clipboard, the user may perform functions that result in items and information being added to the clipboard. For example, the user may perform a copy function, a paste function, a cut function, a delete function, a snapshot function, a print screen function, a snip function, and/or the like. All of these functions result in items and information being stored on the clipboard. These functions can be performed using different techniques, for example, utilizing shortcut keys, selecting the function from a menu, pressing a particular button on a keyboard, utilizing a particular function of an application, and/or the like.

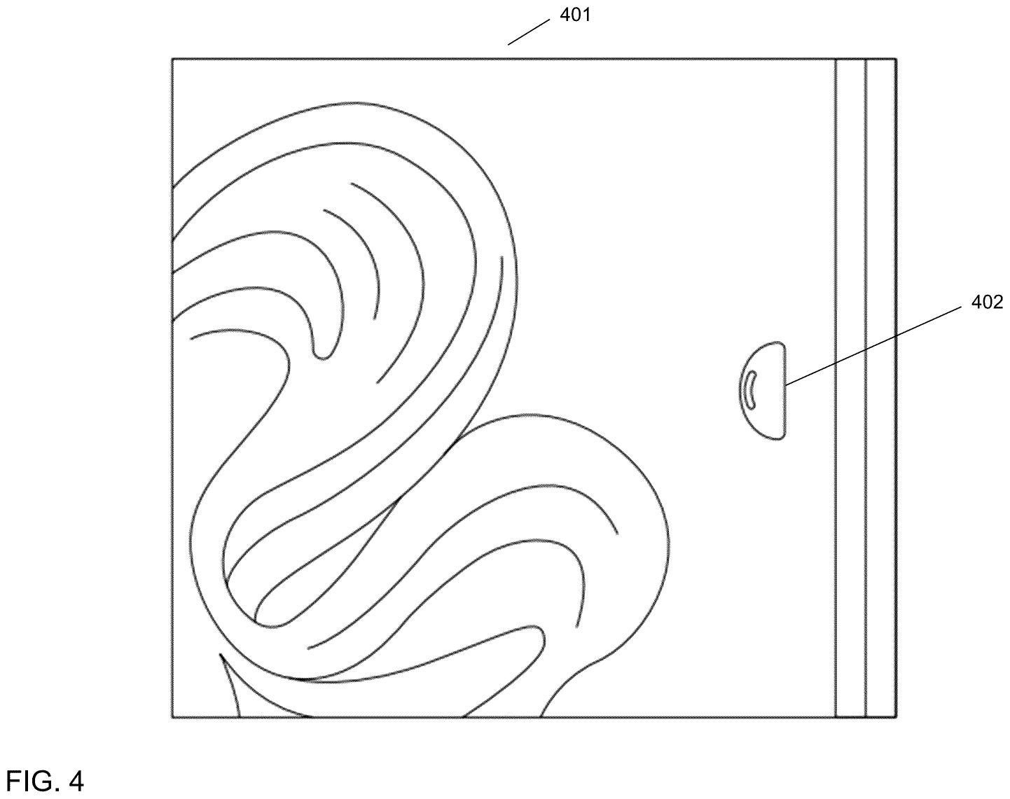

Receipt of the indication may include receipt of any indication that indicates the user wants to access the clipboard. Additionally, the indication could be provided using any type of input modality, for example, a mouse, a touch screen, a keyboard, an image capture device, an electromyography input device, a stylus, a trackpad, a pointing stick, an audio input device, and/or the like. Thus, the indication can be received by receiving input at any of these input devices. If the clipboard has an associated icon, the user could provide an indication by providing input to the icon. An example clipboard icon is illustrated in FIG. 4. The clipboard icon 402 is provided on a display screen 401 of a display. The user could provide input to this icon to provide the indication. Different types of input could be provided to the icon and may be a default input, configured by the user, contained within the user profile, and/or the like. Types of input may include, but are not limited to, clicking the icon, double-clicking the icon, hovering over the icon, looking at the icon, providing a gesture to or directed to the icon, saying a particular phrase, thinking of a particular phrase or object, and/or the like.

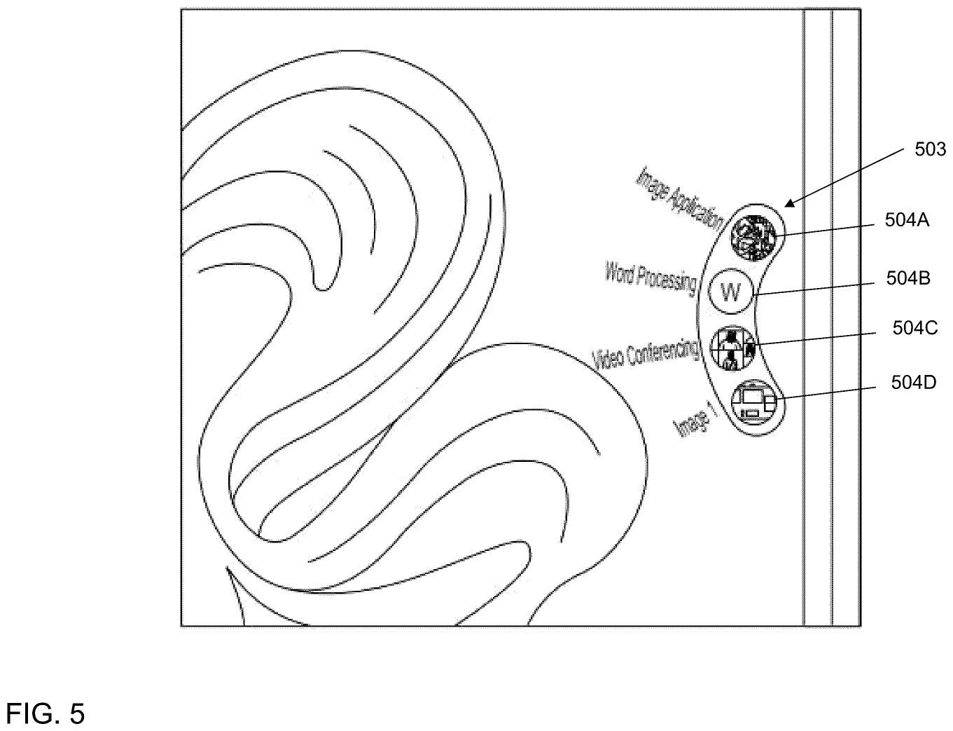

At 302, the clipboard interface system may present a graphical user interface for the clipboard and display a recent copy history of the user within the graphical user interface. In other words, the system may present a graphical user interface for the clipboard that displays a recent copy history of the user. Thus, in the graphical user interface are icons or other representations of the information that is contained on the clipboard. Presenting the graphical user interface may include changing an appearance of the icon that received the input at 301. Using the example illustrated in FIG. 4, the semi-circle icon could change to the graphical user interface of the clipboard. FIG. 5 illustrates such a system where the semi-circle has changed to the graphical user interface. FIG. 5 illustrates an example recent clipboard view at 503. In this recent clipboard view example, the recent clipboard view 503 shows the four most recent items added to the clipboard 504A, 504B, 504C, and 504D. These items include an image captured from an image application 504, text from a word processing document 504B, information captured from a video conferencing application 504C, and an image 504D.

The examples illustrated in the figures are merely examples and different icons and graphical user interfaces can be provided. For example, instead of a semi-circle icon, the system could display a full circle icon, square icon, other shaped icon, a clipboard shape or icon, and/or the like. The graphical user interface could be displayed as a window, a rectangle, a circle, and/or the like. Thus, changing the appearance of the icon into the graphical user interface could include changing the icon into any type of graphical user interface that includes the recent copy history.

The graphical user interface includes the recent copy history which includes the most recent information that has been added to the clipboard. This could include information that was added seconds before accessing the graphical user interface or could include information that was added hours or more before accessing the graphical user interface. In other words, the information contained in the recent copy history could be any information that is typically stored within the clipboard. The graphical user interface that includes the recent copy history will be referred to as the recent clipboard view in order to distinguish it from the expanded clipboard view discussed further herein. The recent clipboard view may include a predetermined number of items or icons. This number may be a default number, configured by the user, included in the user profile, learned by the system over time, identified using an artificial intelligence model, and/or the like. In the example used here throughout, the recent clipboard view includes a maximum of four items that are visible at one time in the recent clipboard view. Even though, in the example, four items are visible at one time, if the clipboard does not contain four items, then the recent clipboard view may only display the items that are on the clipboard.

Even though the recent clipboard view only displays a predetermined number of items at a time, other clipboard items are accessible from this view. This view may allow a user to provide input that allows the user to view earlier items that were added to the clipboard. In other words, the user could provide input that would change the items visible within the recent clipboard view to other items that are stored on the clipboard. One type of input that the user could provide is a scrolling input. Thus, the user could hover over the recent clipboard view and provide the scrolling input. The scrolling input would then change the recent copy history (clipboard items) being displayed to different copy history (different clipboard items) of the user. The scrolling input could be provided via a wheel on a mouse, via a finger scroll on a trackpad or touch screen, via a gesture input at an image capture device, and/or the like.

Another type of input that could be utilized to change the clipboard items visible in the recent clipboard view is a hold-and-drag input. In this input type, the user would provide and hold a selection input and then drag the selection input in one direction or other to change the items visible in the recent clipboard view. A final, non-limiting example, of input that could be utilized to change the clipboard items visible in the recent clipboard view is a predetermined selection input. For example, the user could provide a double click selection input, could provide a selection input in a particular location of the graphical user interface, could provide a selection input having a particular duration, and/or the like, or a combination thereof. These described examples of input are merely illustrative and are not intended to be limiting as other types of input can be utilized to change the clipboard items visible in the recent clipboard view.

At 303, the clipboard interface system may receive a second indication to view an expanded graphical user interface. The second indication may be an input that is provided by the user. The input provided can include any of those described in connection with 301. Depending on where the input is provided, the input received at 301 to result in the presentation of the recent clipboard view may be the same or different than the input provided at 303. The second indication may be received at or on the recent clipboard view. If the second indication is received at or on the recent clipboard view, then the input that is provided here may be the same at the input provided at 301. In other words, and for example, if the input provided at 301 was a single click, the input provided here at 303 could also be a single click. However, the input types may also be different.

One type of different input that may be received at or within the recent clipboard view is a scrolling input. Since a scrolling input can also be utilized to change the information that is visible within the recent clipboard view, the scrolling input to get the expanded view may have a particular characteristic to distinguish it from the scrolling input provided to get different information visible within the recent clipboard view. For example, the scrolling input may exceed a predetermined distance in less than a predetermined length of time. In this case, a distance is a length of movement of the scrolling input at the input device. Thus, the scrolling input may be provided very quickly as compared to the scrolling input utilized to change the information in the recent clipboard view. The predetermined distance and predetermined length of time may be defaults, configurable by the user, stored in the user profile, learned over time, and/or the like.

Another type of different input may be another input that was described in connection with 301, but that is different than what was actually provided as the input. For example, if a single click on the icon resulted in the recent clipboard view, then a double click within the recent clipboard view may be the second indication received at 303. Other types of different input that may be received at or within the recent clipboard view include, but are not limited to, inputs provided with a different modality than that provided at 301, a drag or scrolling input in a particular direction within the recent clipboard view, a user providing inputs using two different modalities (e.g., clicking with a mouse and saying a phrase, touching the recent clipboard view and making a gesture, etc.), and/or the like. Other input types are contemplated and possible.

Alternatively, the second indication may be received at or on the icon representing the clipboard graphical user interface. In other words, using the example as illustrated in the figures, the second indication could be provided at the semi-circle 402. In this case, the input provided at 303 will be different than the input provided at 301 in order to distinguish the two and so the system can understand what function is to be performed. However, the difference may be simply a change in a characteristic of an input, for example, how fast the input is provided, a location of where the input is provided, a button or input modality with which the input is provided, depressing an additional input along with the input, and/or the like.

As an example of different inputs, the user could provide one type of input at the icon that results in a presentation of the recent clipboard view and could provide a different type of input at the icon that results in a presentation of the expanded clipboard view. For example, the user could hover over the icon for a predetermined length of time to get the recent clipboard view and could click or select the icon to get the expanded clipboard view. As another example, the user could single click the icon to get the recent clipboard view and double-click the icon to get the expanded clipboard view. As another example, the user could double-click the icon in an upper portion of the icon to get the recent clipboard view and double-click the icon in a lower portion of the icon to get the expanded clipboard view.

As a final, non-limiting example, the user could look at the icon and provide one gesture to get the recent clipboard view and look at the icon and provide a different gesture to get the expanded clipboard view. Other techniques for providing two different inputs to get either the recent clipboard view or the expanded clipboard view based upon the input provided are contemplated and possible. Thus, these examples are merely illustrative and are not intended to be limiting. Additionally, the types of inputs and the function performed based upon the received inputs can be defaults, user configurable, stored within the user profile, learned over time by the system, and/or the like.

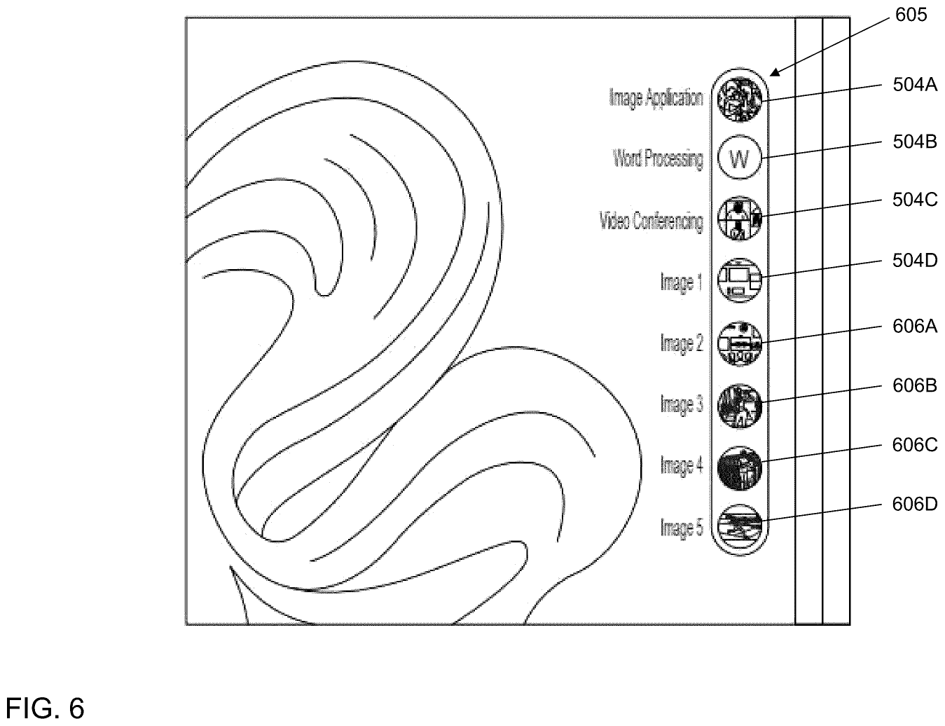

At 304, the clipboard interface system may expand, responsive to receiving the second indication, the graphical user interface for the clipboard into an expanded graphical user interface and displaying additional copy history in addition to the recent copy history within the expanded graphical user interface. In other words, the clipboard interface system may expand the graphical user interface for the clipboard into an expanded graphical user interface that displays the clipboard and additional copy history as compared to the graphical user interface displayed at 302. Thus, within the expanded clipboard view, there are more clipboard items visible to the user. FIG. 6 illustrates an example expanded clipboard view at 605. In this expanded clipboard view example, the expanded clipboard view 605 includes the four most recent items added to the clipboard 504A, 504B, 504C, and 504D (which were also included in the recent clipboard view 503 of FIG. 5. Additionally, the expanded clipboard view includes four of the next most recent items added to the clipboard 606A, 606B, 606C, and 606D. These items include a second image 606A, a third image 606B, a fourth image 606C, and a fifth image 606D.

The user can also interface with the expanded clipboard view in similar manners to the recent clipboard view. For example, the user could provide scrolling input within the expanded view to change the copy history that is being displayed to different copy history. In other words, the system could receive a scrolling input within the expanded graphical user interface and changing the additional copy history and the recent copy history being displayed to different copy history. As another example, the user could provide a third indication to revert the graphical user interface to the recent clipboard view. In response to this third indication, the clipboard interface system may contract the expanded clipboard view back to the recent clipboard view. The third indication can be any of the indications that were previously described in connection with 301 and 303.

The user can also interact with the information contained within the clipboard view. Once the clipboard view is open, either the recent clipboard view or the expanded clipboard view, the user can interact with the information displayed within the clipboard view. For example, the user could select a piece of information and copy it to a destination location (e.g., application, window, data storage location, etc.). As another example, the user could select a piece of information and open it within a window. As another example, the user could delete information contained within the clipboard and thereby delete it from the clipboard. As a final, non-limiting example, the user could click on the information and have it restored to the originating location. Other interactions are contemplated and possible.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a clipboard interface system, an indication to access a clipboard storing a copy history of a user;
presenting, responsive to the receiving the indication, a graphical user interface for the clipboard and displaying a recent copy history of the user within the graphical user interface;
receiving, at the clipboard interface system, a second indication to view an expanded graphical user interface; and
expanding, responsive to the receiving the second indication, the graphical user interface for the clipboard into an expanded graphical user interface and displaying additional copy history in addition to the recent copy history within the expanded graphical user interface.

2. The method of claim 1, wherein the receiving the indication comprises receiving input at an icon associated with the clipboard.

3. The method of claim 2, wherein the presenting comprises changing an appearance of the icon into the graphical user interface.

4. The method of claim 2, wherein the receiving the second indication comprises receiving a second input at the icon being of a different type than the input received at the icon.

5. The method of claim 1, comprising receiving a scrolling input within the graphical user interface and changing the recent copy history being displayed to different copy history.

6. The method of claim 1, wherein the receiving the second indication comprises receiving a scrolling input within the graphical user interface that exceeds a predetermined distance in less than a predetermined length of time.

7. The method of claim 1, wherein the receiving a second indication comprises receiving a predetermined input within the graphical user interface.

8. The method of claim 1, comprising receiving a scrolling input within the expanded graphical user interface and changing the additional copy history and the recent copy history being displayed to different copy history.

9. The method of claim 1, comprising receiving a third indication to revert the graphical user interface and contracting the expanded graphical user interface back to the graphical user interface.

10. The method of claim 1, wherein the receiving an indication and the receiving a second indication comprises receiving input at an input device selected from the group consisting of: a touch screen, a trackpad, a pointing stick, a stylus, a mouse, and an image capture device.

11. A system, the system comprising:
a processor;
a memory device that stores instructions that, when executed by the processor, causes the system to:
receive, at a clipboard interface system, an indication to access a clipboard storing a copy history of a user;
present, responsive to the receiving the indication, a graphical user interface for the clipboard and displaying a recent copy history of the user within the graphical user interface;
receive, at the clipboard interface system, a second indication to view an expanded graphical user interface; and
expand, responsive to the receiving the second indication, the graphical user interface for the clipboard into an expanded graphical user interface and displaying additional copy history in addition to the recent copy history within the expanded graphical user interface.

12. The system of claim 11, wherein the receiving the indication comprises receiving input at an icon associated with the clipboard.

13. The method of claim 12, wherein the presenting comprises changing an appearance of the icon into the graphical user interface.

14. The method of claim 12, wherein the receiving the second indication comprises receiving a second input at the icon being of a different type than the input received at the icon.

15. The system of claim 11, comprising receiving a scrolling input within the graphical user interface and changing the recent copy history being displayed to different copy history.

16. The system of claim 11, wherein the receiving the second indication comprises receiving a scrolling input within the graphical user interface that exceeds a predetermined distance in less than a predetermined length of time.

17. The system of claim 11, wherein the receiving a second indication comprises receiving a predetermined input within the graphical user interface.

18. The system of claim 11, comprising receiving a scrolling input within the expanded graphical user interface and changing the additional copy history and the recent copy history being displayed to different copy history.

19. The system of claim 11, comprising receiving a third indication to revert the graphical user interface and contracting the expanded graphical user interface back to the graphical user interface.

20. A product, the product comprising:
a computer-readable storage device that stores executable code that, when executed by a processor, causes the product to:
receive, at a clipboard interface system, an indication to access a clipboard storing a copy history of a user;
present, responsive to the receiving the indication, a graphical user interface for the clipboard and displaying a recent copy history of the user within the graphical user interface;
receive, at the clipboard interface system, a second indication to view an expanded graphical user interface; and
expand, responsive to the receiving the second indication, the graphical user interface for the clipboard into an expanded graphical user interface and displaying additional copy history in addition to the recent copy history within the expanded graphical user interface.
